(19) United States
(12) Patent Application Publication
(10) Pub. No.: US 2008/0147385 A1
(43) Pub. Date: Jun. 19, 2008

(54) MEMORY-EFFICIENT METHOD FOR HIGH-QUALITY CODEBOOK BASED VOICE CONVERSION

(75) Inventors: Jani Nurminen, Lempaala (FI); Jilei Tian, Tampere (FI); Victor Popa, Tampere (FI)

Correspondence Address: FOLEY & LARDNER LLP, P.O. BOX 80278, SAN DIEGO, CA, 92138-0278, US

(73) Assignee: Nokia Corporation

(21) Appl. No.: 11/611,798

(22) Filed: Dec. 15, 2006

(51) Int. Cl. G10L 19/12

(52) U.S. Cl. 704/223

(57) ABSTRACT

An improved system method for enabling and implementing codebook-based voice conversion that both significantly reduces the memory footprint and improves the continuity of the output. In various embodiments, the paired source-target codebook is implemented as a multi-stage vector quantizer. During the conversion, N best candidates in a tree search are taken as the output from the quantizer. The N candidates for each vector to be converted are used in a dynamic programming-based approach that finds a smooth but accurate output sequence.

### FIELD OF THE INVENTION

The present invention relates generally to speech processing. More particularly, the present invention relates to the implementation of voice conversion in speech processing.

### BACKGROUND OF THE INVENTION

This section is intended to provide a background or context to the invention that is recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

Voice conversion is a technique that is used to effectively shield a speaker's identity, i.e., to modify the speech of a source speaker, such that it sounds as if the speech were spoken by a different, “target” speaker.

A variety of different voice conversion systems are currently under development, and such systems may be used in a variety of applications. For example, voice conversion can be utilized for extending the language portfolio of high-end text-to-speech (TTS), also referred to as high-quality or HQ TTS systems for branded voices in a cost efficient manner. In this context, voice conversion can be used to make a branded synthetic voice speak in languages that the original individual cannot speak. In addition, new TTS voices can be created using voice conversion, and the same techniques can be used in several types of entertainment applications and games. There are also several new features that could be implemented using the voice conversion technology, such as text message reading with the voice of the sender.

One technique that can be used in voice conversion involves utilizing a codebook-based approach. A codebook is a collection acoustic units of speech sounds that a person utters. Codebooks are structured to provide a one-to-one mapping between unit entries in a source codebook and the unit entries in the target codebook. The codebook is sometimes implemented by incorporating all of the available training data into the codebook, and sometimes a smaller codebook is generated. Codebook-based voice conversion is discussed in M. Abe, S. Nakamura, K. Shikano, H. Kuwabara, “Voice Conversion through Vector Quantization”, in Proceedings of ICASSP, April 1988, the content of which is incorporated herein by reference in its entirety.

Although promising, codebook-based techniques have traditionally suffered from a number of drawbacks. For example, when codebooks are used, the output often contains a number of discontinuities. Additionally, the memory requirements and the computational complexity can become large using a codebook-based approach if the objective is to achieve accurate conversion results. One attempt to improve the continuity issue in voicebook-based voice conversion is discussed in L. M Arslan, David Talkin, “Voice Conversion by Codebook Mapping of Line Spectral Frequencies and Excitation Spectrum”, in Proceedings of Eurospeech, September 1997, the content of which is incorporated herein by reference in its entirety. However, it would be desirable to still further alleviate the issues discussed above, while also improve the conversion accuracy when codebook-based approaches are used.

### SUMMARY OF THE INVENTION

Various embodiments of the present invention provide an improved system method for codebook-based voice conversion that both significantly reduces the memory footprint and improves the continuity of the output. The various embodiments may also serve to reduce the computational complexity and enhance the conversion accuracy. The footprint reduction is achieved by implementing the paired source-target codebook as a multi-stage vector quantizer (MSVQ). During the conversion, N best candidates in a tree search are taken as the output from the quantizer. The N candidates for each vector to be converted are used in a dynamic programming-based approach that finds a smooth but accurate output sequence. The method is flexible and can be used in different voice conversion systems. In addition to the above, the various embodiments can be used to avoid over-fitting training data; they can be adjusted to different use cases; and they are scalable to different memory footprints and complexity levels. Still further, the system and method comprise a fully data-driven technique; there is no requirement to gather any language-specific knowledge.

The various embodiments of the present invention can be used in conjunction with the voice conversion framework described in U.S. patent application Ser. No. 11/107,334, filed Apr. 15, 2005 and incorporated herein by reference in its entirety.

These and other advantages and features of the invention, together with the organization and manner of operation thereof, will become apparent from the following detailed description when taken in conjunction with the accompanying drawings, wherein like elements have like numerals throughout the several drawings described below.

### BRIEF DESCRIPTION OF THE DRAWINGS

FIG. 1 is a depiction of a M-L tree search procedure for use with various embodiments of the present invention;

FIG. 2 is a perspective view of a mobile telephone that can be used in the implementation of the present invention; and

FIG. 3 is a schematic representation of the telephone circuitry of the mobile telephone of FIG. 2.

### DETAILED DESCRIPTION OF THE PREFERRED EMBODIMENTS

Various embodiments of the present invention provide an improved system method for codebook-based voice conversion that both significantly reduces the memory footprint and improves the continuity of the output. The various embodiments may also serve to reduce the computational complexity and enhance the conversion accuracy. The method is flexible and can be used in different voice conversion systems. In addition to the above, the various embodiments can be used to avoid over-fitting training data; they can be adjusted to different use cases; and they are scalable to different memory footprints and complexity levels. Still further, the system and method comprise a fully data-driven technique; there is no requirement to gather any language-specific knowledge.

The footprint reduction is achieved in the various embodiments of the present invention by implementing the paired source-target codebook as a MSVQ. During the conversion, N best candidates in a tree search are taken as the output from the quantizer. The N candidates for each vector to be converted are used in a dynamic programming-based approach that finds a smooth but accurate output sequence.

The training of the paired source-target quantizer is performed in a joint source-target space, using a distortion measure operating in the source-target space. All of the individual stages can be trained simultaneously using a multistage vector quantizer simultaneous joint design algorithm. One such algorithm is described in detail in LeBlanc, W. P., Bhattacharya, B., Mahmoud, S. A. & Cuperman, V., “Efficient Search and Design Procedures for Robust Multi-Stage VQ of LPC Parameters for 4 kb/s Speech Coding”, IEEE Transactions on Speech and Audio Processing 1, 4 (1993). p. 373-385, the contents of which are incorporated herein by reference in its entirety. Once training has been completed, a search is performed using only the source side of the space, while the output is produced using only the target portions of the joint vectors.

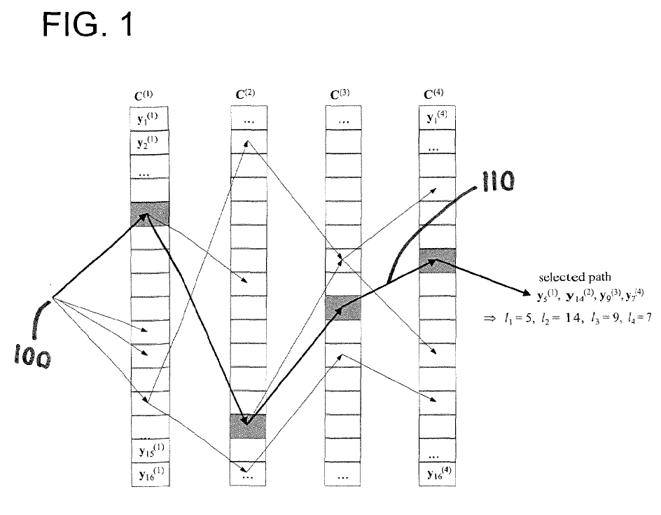

For the MSVQ, the number of stages and the sizes of the stages can be adjusted depending on design goals, including goals relating to target accuracy, memory consumption, computational complexity, etc. The search procedure can be implemented, for example, using a M-L tree search procedure. This procedure is depicted in FIG. 1. The search procedure depicted in FIG. 1 includes four stages, designated C⁽¹⁾, C⁽²⁾, C⁽³⁾ and C⁽⁴⁾, respectively. For each stage, the search procedure in FIG. 1 defines sixteen different vectors for selection. For each stage, a predefined number of best candidate paths are selected for further processing. Due to this implementation choice, the search can output the N best candidates as a side product. It should be noted that the search procedure needs to remember the best paths during the intermediate processes. The value of N can be set according to design requirements and/or preferences.

After the N best candidates are available for a given number of vectors to be converted, the optimized output sequence is obtained using dynamic programming. For each candidate, the corresponding source-space distance is stored during the search procedure. In addition, a transition distance is computed between each neighboring candidate pair. These distances together are used in the dynamic programming-based approach for finding an “optimal output sequence,” i.e. the path that results in the smallest overall distance. The relative importance between the accuracy and the smoothness can be set using user-defined or predetermined weighting factors.

In the depiction shown in FIG. 1, a plurality of potential multi-stage vectors are considered beginning at an initial point 100. The selected path 110 is chosen based upon the overall smoothness and accuracy of the paths. In this depiction, the selected path is based on selecting vector 5 in stage 1, vector 14 in stage 2, vector 9 in stage 3, and vector 7 in stage 4.

The following compares the use of one embodiment of the present invention with a pair of conventional conversion systems. These method were tested in a practical voice conversion environment in the conversion of the line spectral frequencies (LSFs). The 10-dimensional LSF parameters were estimated from 90 sentences at 10 millisecond intervals. 14,942 vectors were selected for training, and a distinct set of another 14,942 vectors were used for testing. As mentioned above, this test included three models. The first model followed an embodiment of the present invention, using three stages with 16 vectors in each stage. The second model included a full codebook containing all of the training vectors. The third model contained a small codebook having the same footprint as the embodiment of the present invention described in the first model (with real source-target vectors). The dynamic programming process was omitted to obtain comparable results.

The three models were evaluated from three different viewpoints: performance/accuracy, memory requirements, and computational load. The accuracy was measured using the average mean squared error, while the memory requirements were computed as the number of vector elements that have to be stored in the memory. The computational load was estimated as the number of vector comparisons required during the search procedure. The results of the evaluation, computed using the testing data, are summarized in Table 1 below.

TABLE 1

| Criteria | Model 1 | Model 2 | Model 3 |
|---|---|---|---|
| Accuracy | 3.62 | 4.12 | 4.79 |
| (MSE, *10⁴) | | | |
| Memory (Number | 960 | 298,840 | 960 |
| of Vector | | | |
| Elements) | | | |
| Complexity | 144 | 14,942 | 48 |
| (Number of Vector | | | |
| Comparisons) | | | |

The results outlined in Table 1 show that the selected embodiment of the present invention performed strongly from all aspects: it clearly provided the best accuracy and the lowest memory usage. While the third model offered similar memory and complexity levels, the conversion accuracy was significantly lower that the selected embodiment of the present invention.

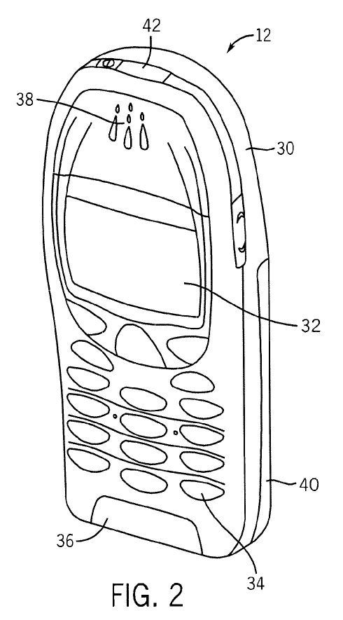

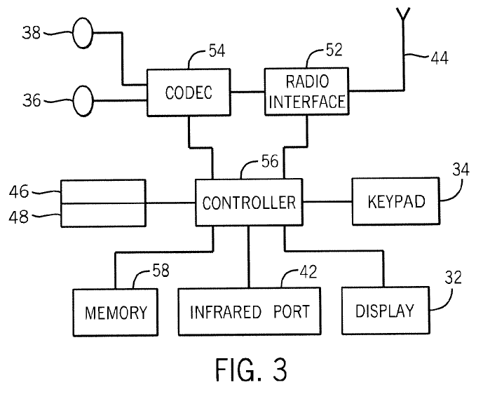

FIGS. 2 and 3 show one representative electronic device 12 within which the present invention may be implemented. It should be understood, however, that the present invention is not intended to be limited to one particular type of electronic device 12. The electronic device 12 of FIGS. 2 and 3 includes a housing 30, a display 32 in the form of a liquid crystal display, a keypad 34, a microphone 36, an ear-piece 38, a battery 40, an infrared port 42, an antenna 44, a smart card 46 in the form of a UICC according to one embodiment of the invention, a card reader 48, radio interface circuitry 52, codec circuitry 54, a controller 56, a memory 58. Individual circuits and elements are all of a type well known in the art, for example in the Nokia range of mobile telephones.

The present invention is described in the general context of method steps, which may be implemented in one embodiment by a program product including computer-executable instructions, such as program code, executed by computers in networked environments. Generally, program modules include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps.

Software and web implementations of the present invention could be accomplished with standard programming techniques with rule based logic and other logic to accomplish the various database searching steps, correlation steps, comparison steps and decision steps. It should also be noted that the words “component” and “module,” as used herein and in the claims, is intended to encompass implementations using one or more lines of software code, and/or hardware implementations, and/or equipment for receiving manual inputs.

The foregoing description of embodiments of the present invention have been presented for purposes of illustration and description. It is not intended to be exhaustive or to limit the present invention to the precise form disclosed, and modifications and variations are possible in light of the above teachings or may be acquired from practice of the present invention. The embodiments were chosen and described in order to explain the principles of the present invention and its practical application to enable one skilled in the art to utilize the present invention in various embodiments and with various modifications as are suited to the particular use contemplated.

What is claimed is:

1. A method of enabling codebook-based voice conversion, comprising:
creating paired source-target codebook using a paired source-target multistage vector quantizer, the codebook being trained by, for each of a plurality of training audio items:
at each of a plurality of stages of the multistage vector quantizer, selecting a predefined number of optimal candidate paths for further processing,
identifying a plurality of candidate vector sequences based upon the selected candidate paths for each stage, and
selecting an optimal candidate vector sequence from the 11 plurality of candidate vector sequences.

2. The method of claim 1, wherein training occurs substantially simultaneously for each stage of the multistage vector quantizer.

3. The method of claim 2, wherein the simultaneous training occurs through the use of a multistage vector quantizer simultaneous joint design algorithm.

4. The method of claim 1, wherein the number of stages in the multistage vector quantizer is selected based on at least one factor selected from the group consisting of target accuracy, memory consumption, and computational complexity.

5. The method of claim 1, wherein the optimal candidate vector sequence is selected based upon a combination of relative smoothness of candidate vector sequences and accuracy of the candidate vector sequences.

6. The method of claim 1, wherein the plurality of stages include a search stage and a target stage, and further comprising:
upon receiving an input audio item for conversion, matching the input audio item with an appropriate vector at the search stage; and
outputting a converted audio item based upon the optimal candidate vector sequence selected for the input audio item during training.

7. A computer program product, embodied in a computer-readable medium, for enabling codebook-based voice conversion, comprising:
computer code for creating paired source-target codebook using a paired source-target multistage vector quantizer, the codebook being trained by, for each of a plurality of training audio items:
at each of a plurality of stages of the multistage vector quantizer, selecting a predefined number of optimal candidate paths for further processing,
identifying a plurality of candidate vector sequences based upon the selected candidate paths for each stage, and
selecting an optimal candidate vector sequence from the plurality of candidate vector sequences.

8. The computer program product of claim 7, wherein training occurs substantially simultaneously for each stage of the multistage vector quantizer.

9. The computer program product of claim 8, wherein the simultaneous training occurs through the use of a multistage vector quantizer simultaneous joint design algorithm.

10. The computer program product of claim 7, wherein the number of stages in the multistage vector quantizer is selected based on at least one factor selected from the group consisting of target accuracy, memory consumption, and computational complexity.

11. The computer program product of claim 7, wherein the optimal candidate vector sequence is selected based upon a combination of relative smoothness of candidate vector sequences and accuracy of the candidate vector sequences.

12. The computer program product of claim 7, wherein the plurality of stages include a search stage and a target stage, and further comprising:
computer code for, upon receiving an input audio item for conversion, matching the input audio item with an appropriate vector at the search stage; and
computer code for outputting a converted audio item based upon the optimal candidate vector sequence selected for the input audio item during training.

13. An apparatus, comprising:
a processor; and
a memory unit communicatively connected to the processor and including computer code for creating paired source-target codebook using a paired source-target multistage vector quantizer, the codebook being trained by, for each of a plurality of training audio items:
at each of a plurality of stages of the multistage vector quantizer, selecting a predefined number of optimal candidate paths for further processing,
identifying a plurality of candidate vector sequences based upon the selected candidate paths for each stage, and
selecting an optimal candidate vector sequence from the plurality of candidate vector sequences.

14. The apparatus of claim 13, wherein training occurs substantially simultaneously for each stage of the multistage vector quantizer.

15. The apparatus of claim 14, wherein the simultaneous training occurs through the use of a multistage vector quantizer simultaneous joint design algorithm.

16. The apparatus of claim 13, wherein the number of stages in the multistage vector quantizer is selected based on at least one factor selected from the group consisting of target accuracy, memory consumption, and computational complexity.

17. The apparatus of claim 13, wherein the optimal candidate vector sequence is selected based upon a combination of relative smoothness of candidate vector sequences and accuracy of the candidate vector sequences.

18. The apparatus of claim 13, wherein the plurality of stages include a search stage and a target stage, and wherein the memory unit further comprises:
computer code for, upon receiving an input audio item for conversion, matching the input audio item with an appropriate vector at the search stage; and
computer code for outputting a converted audio item based upon the optimal candidate vector sequence selected for the input audio item during training.
